(19) United States
(12) Patent Application Publication
(10) Pub. No.: US 2014/0036140 A1
(43) Pub. Date: Feb. 6, 2014

(54) CAMERA MODULE HAVING MOVABLE IMAGE SENSOR FOR FOCUSING

(71) Applicant: Hon Hai Precision Industry Co., Ltd., New Taipei (TW)

(72) Inventors: SHAO-HUNG WANG, New Taipei (TW); FENG-YANG MA, New Taipei (TW)

(21) Appl. No.: 13/903,000

(22) Filed: May 28, 2013

(30) Foreign Application Priority Data
Aug. 1, 2012 (TW) 101127832

(51) Int. Cl. H04N 5/232

(52) U.S. Cl. CPC H04N 5/232
USPC 348/357

(57) ABSTRACT

A camera module includes a lens holder, a lens held by the lens holder, an image sensor, a guiding device, and a driving motor. The lens holder includes guiding rods which impose a movement track on the guiding device so as to hold the image sensor very steadily and precisely for focusing purposes, in moving towards or away from the lens.

### BACKGROUND

1. Technical Field

The present disclosure relates to camera modules and, particularly, to a camera module having a movable image sensor for focusing.

2. Description of Related Art

Camera modules include a lens and an image sensor aligned with the lens. Current cameras focus by driving the image sensor to move in relation to the lens. However, the image sensor may move out of alignment when being driven to move by a current driving system and degrade preview image quality, thus adversely affecting the focusing.

Therefore, it is desirable to provide a camera module, which can overcome the above-mentioned problems.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is an isometric schematic view of a camera module, according to an embodiment.

FIG. 2 is an exploded view of the camera module of FIG. 1.

FIG. 3 is a cross-sectional view of the camera module of FIG. 1.

FIG. 4 is a cut-away view of the camera module of FIG. 1.

FIG. 5 is a partial, enlarged view of the camera module of FIG. 1.

### DETAILED DESCRIPTION

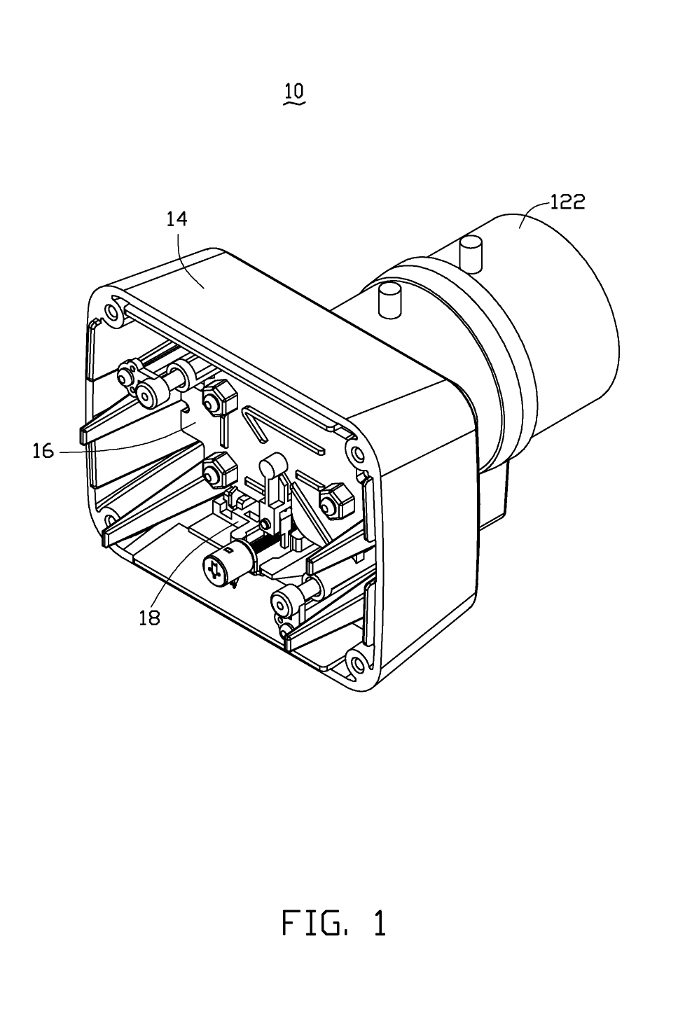

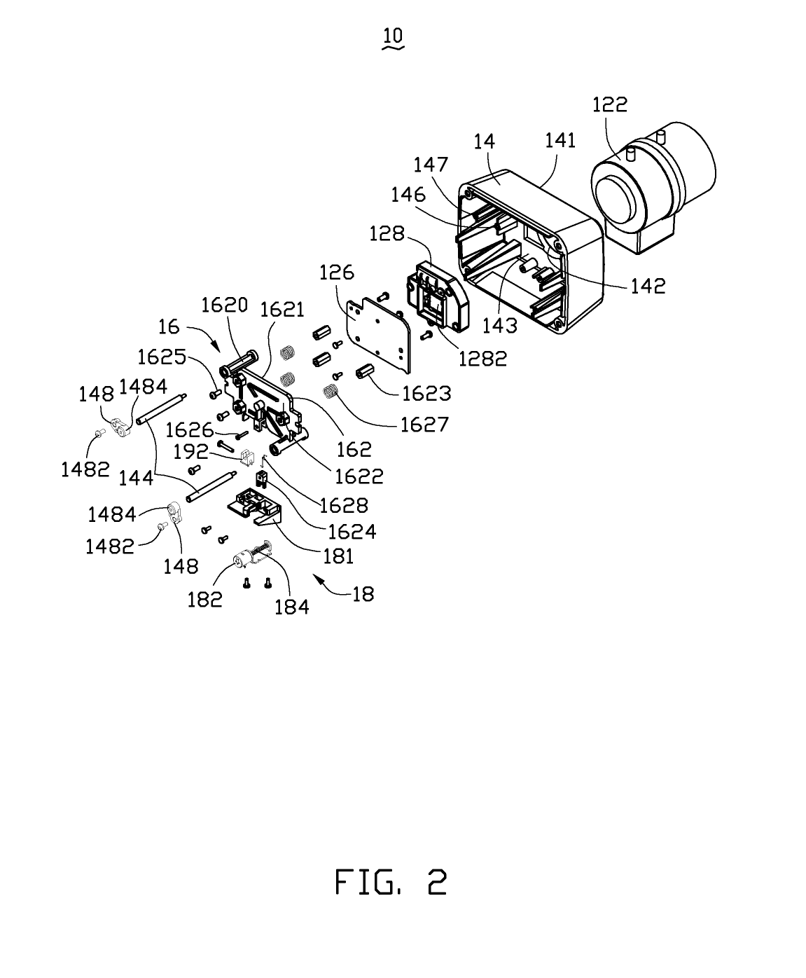

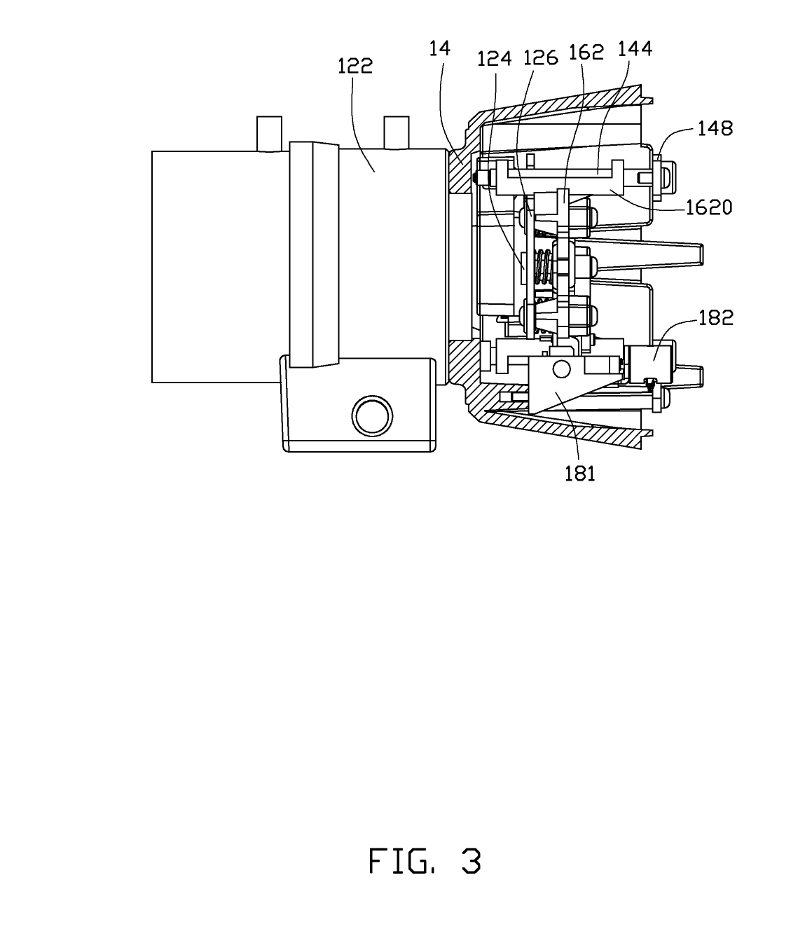

Referring to FIGS. 1-3, a camera module 10, according to an embodiment, includes a lens 122, an image sensor 124, a printed circuit board 126, a filter assembly 128, a lens holder 14, a guiding device 16, and an activating device 18.

The image sensor 124 is positioned on and electrically connected to the printed circuit board 126. The filter assembly 128 includes a filter 1282 and is fixed to the printed circuit board 126 such that the filter 1282 covers the image sensor 124. In other embodiments, the filter assembly can be omitted.

The lens holder 14 includes a upper plate 141 and defines a through hole 142 running through a center of the upper plate 141. The upper plate 141 has an inner surface 143. The lens holder 14 includes a number of reinforced short sockets 146 and a number of reinforced long sockets 147 extending upward from the inner surface 143 and surrounding the through hole 142. The lens holder 14 also includes a number of guiding rods 144 and a number of fixing devices 148. Each guiding rod 144 is inserted into one of the short sockets 146. Each fixing device 148 includes a fixing portion 1481, a first screw 1482, and a fixing cap 1484. The first screw 1482 is screwed through the fixing portion 1481 into one of the long sockets 147 to fix the fixing portion 1481 on the long socket 147. The fixing cap 1484 is integrally formed with the fixing portion 1481 and caps one of the guiding rods 144. Thus, the guiding rods 144 are fixed to the lens holder 14.

The lens 122 is held by the lens holder 14 by inserting the lens 122 into the through hole 142. An optical axis of the lens 122 is substantially perpendicular to the inner surface 141.

The guiding device 16 includes a base 162 and a number of guiding tubes 1620. The guiding tubes 1620 are fixed to an outer periphery of the base 162 and are slidable on the guiding rods 144. As such, the base 162 can slide substantially along the guiding rods 144. A sidewall of each guiding tube 1620 has cutouts of material to reduce a contact surface between the guiding tube 1620 and the guiding rod 144, reducing friction therebetween.

In this embodiment, numbers of the guiding rods 144, the short sockets 146, the long sockets 147, the fixing devices 148, and the guiding tubes 1620 are two but can be changed to more than two in other embodiments.

In other embodiments, the guiding rods 144 can be arranged to be perpendicular to the inner surface 143 by methods other than the method of this embodiment. For example, the guiding rods 144 can extend up from the inner surface 143 directly.

The base 162 includes a first surface 1621 and a second surface 1622 opposite the first surface 1621. The first surface 1621 faces and is substantially parallel to the inner surface 143.

The guiding device 16 includes a number of sleeves 1623, a number of coil springs 1627, and a number of second screws 1625. The printed circuit board 126 is fixed above the base 1620 by threadedly inserting the second screws 1625 through the base 162, the sleeves 1623, and into the printed circuit board 126. The image sensor 124 is at a side of the printed circuit board 126 opposite to the base 162 and faces the lens 122. The coil springs 1627 sleeve on the sleeves 1623 and are compressed between the base 162 and the printed circuit board 126. As such, by screwing the second screws 1626, the printed circuit board 126 can be adjusted to be precisely parallel with the first surface 1621 such that the optical axis of the lens 122 is substantially perpendicular to the image sensor 124. The image sensor 124 is movable in relation to the lens 122 when the guiding tubes 1620 slide on the guiding rod 144.

In other embodiments, the printed circuit board 126 can be fixed to the base 162 by methods other than the method of this embodiment. For example, the printed circuit board can be fixed to the base 162 directly.

In this embodiment, the number of the sleeves 1623, of the second screws 1626, and of the coil springs 1627 are all three but can be changed in other embodiments.

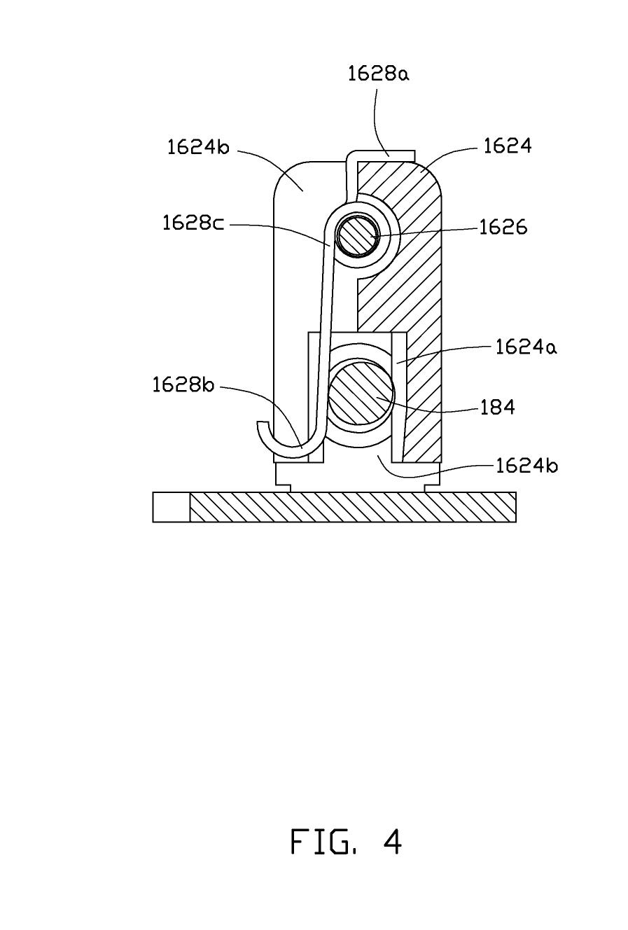

Also referring to FIG. 4, the guiding device 16 also includes an engagement block 1624 and a shaft 1626. The engagement block 1624 is rotatably arranged on the second surface 1622 by the shaft 1626. The shaft 1626 is substantially perpendicular to the second surface 1626. The engagement block 1624 defines a groove 1624b extending along a direction that is substantially perpendicular to the second surface 1622 and teeth 1624a are formed on a sidewall of the groove 1624b. The activating device 18 includes a seat 181, a motor 182, and a threaded rod 184. The seat 181 is fixed to the lens holder 14 by screws (not labeled). The motor 182 is seated on the seat 181 by screws (not labeled) and drives the threaded rod 184 to rotate. The threaded rod 184 is substantially perpendicular to the second surface 1622 and engages with the teeth 1624a. Thus, the engagement block 1624 can be driven along the threaded rod 184. As a consequence, the base 162 along with the image sensor 124 move in a direction that is substantially parallel with the optical axis of the lens 122, to focus the camera module 10.

The guiding device 16 further includes a torsion spring 1628. The torsion spring 1628 has a central coil portion 1628c and two distal ends 1628a, 1628b. The coil portion 1628c is sleeved on the shaft 1626 and the two distal ends 1628a, 1628b abut against the base 162 and the engagement block 1624 to remove slack or play between the teeth 1624a and the threaded rod 184.

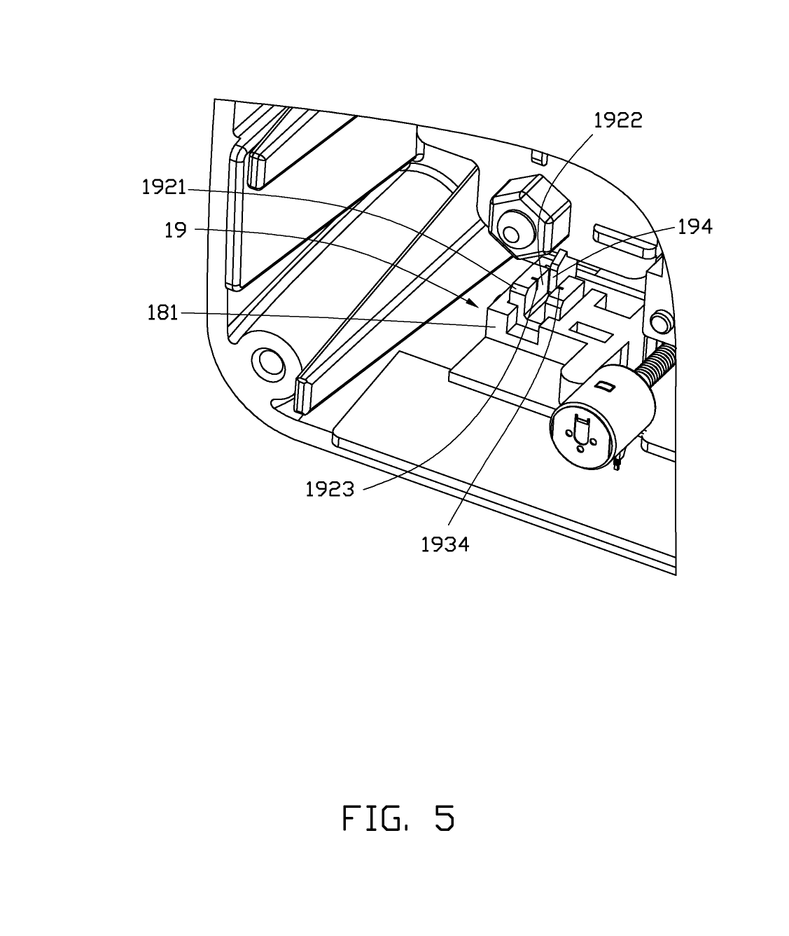

Referring to FIG. 5, the camera module 10 also includes a position sensor 19. The position sensor 19 includes a photoelectric assembly 192 and a barrier plate 194. The photoelectric assembly 192 includes a carrier block 1921 which is secured to the seat 181 and defines a slot 1922 which extends along a direction that is substantially perpendicular to the second surface 1622. The photoelectric assembly 192 also includes a light emitter 1923 and a light receiver 1924 fixed to opposite sidewalls of the slot 1922. The light receiver 1923 receives light emitted from the light emitter 1923. The barrier plate 194 is fixed to the base 162, extending along a direction that is substantially perpendicular to the second surface 1622 and positioned in the slot 1922. As such, when the base 16 is driven to move towards the light emitter 1923 and the light receiver 1924 by the activating device 18, the barrier plate 194 interposes itself between the light emitter 1923 and the light receiver 1924 thus reducing optical communication between the two. A position of the image sensor 124 when the carrier plate 194 starts to interpose itself between the light emitter 1923 and the light receiver 1924 is defined as an initial position. The position sensor 19 detects the initial position.

It will be understood that the above particular embodiments are shown and described by way of illustration only. The principles and the features of the present disclosure may be employed in various and numerous embodiment thereof without departing from the scope of the disclosure as claimed. The above-described embodiments illustrate the possible scope of the disclosure but do not restrict the scope of the disclosure.

What is claimed is:

1. A camera module, comprising
a lens holder comprising a upper plate, the upper plate defining a through hole and comprising an inner surface, the lens holder comprising at least two guiding rods arranged to be perpendicular to the inner surface;
a lens held by the lens holder by inserting into the through hole;
a guiding device, comprising:
a base comprising a first surface and a second surface opposite to the first surface;
at least two guiding tube fixed to the base and sliding on the at least two guiding rods, the first surface facing the inner surface; and
an engagement block positioned on the base;
a printed circuit board positioned on the first surface;
an image sensor fixed to the printed circuit board and opposite to the base and facing the lens; and
an activating device, comprising:
a seat fixed to the lens holder;
a threaded rod arranged to be perpendicular to the second surface and threadedly engaged with the engagement block; and
a motor seating on the seat and configured for driving the threaded rod to rotate, so as to bring the base along with the image sensor to move in relation to the lens.

2. The camera module of claim 1, comprising a filter assembly fixed to the printed circuit board and opposite to the base, the filter assembly comprising a filter covering the image sensor.

3. The camera module of claim 1, wherein the lens holder comprises a plurality of short sockets and a plurality of long sockets extending upward from the inner surface and surrounding the through hole, the lens holder comprises a plurality of guiding rods and a plurality of fixing devices, each guiding rod is inserted into a respective one of the short sockets, each fixing device comprises a fixing portion, a first screw, and a fixing cap, the first screw is screwed through the fixing portion and into a respective one of the long sockets to fix the fixing portion on the long socket, the fixing cap is integrally formed with the fixing portion and caps a respective one of the guiding rods, the guiding device comprises a plurality of guiding tubes, and the guiding tubes are fixed to an outer periphery of the base and are slidable on the guiding rods.

4. The camera module of claim 3, wherein a sidewall of each guiding tube is partially cut out.

5. The camera module of claim 1, wherein the guiding device comprises a shaft and a torsion spring, the engagement block is rotatably arranged on the second surface by the shaft, the shaft is substantially perpendicular to the second surface, the engagement block defines a groove extending therethrough along a direction that is substantially perpendicular to the second surface and forms teeth on a sidewall of the groove, the torsion spring comprises a central coil portion and two distal ends, the coil portion is sleeved on the shaft and the two distal ends abut against the base and the engagement block to cause the teeth abutting against the threaded rod.

6. The camera module of claim 1, wherein the camera module comprises a position sensor, the position sensor comprises a photoelectric assembly and a barrier plate, the photoelectric assembly comprises a carrier block which is secured to the seat and defines a slot which extends along a direction that is substantially perpendicular to the second surface, the photoelectric assembly comprises a light emitter and a light receiver fixed to two opposite sidewalls of the slot, the light receiver is configured for receiving light emitted from the light emitter, the barrier plate is fixed to the base, extending along a direction that is substantially perpendicular to the second surface and positioned in the slot, the barrier plate is configured for inserting between and barring communication between the light emitter and the light receiver when the base is driven to move towards the light emitter and the light receiver by the activating device.
